(19) United States
(12) Patent Application Publication
(10) Pub. No.: US 2025/0307116 A1
(43) Pub. Date: Oct. 2, 2025

(54) DEBUGGING MICROSERVICES IN A CONTAINERIZED APPLICATION

(71) Applicant: Dell Products L.P., Round Rock, TX (US)

(72) Inventors: VINAY SAWAL, Fremont, CA (US); ANIL VENKATESH VARKHEDI, Bengaluru (IN); SUMEET DHAMEJA, Markham (CA)

(21) Appl. No.: 18/621,519

(22) Filed: Mar. 29, 2024

(51) Int. Cl. G06F 11/36; G06F 9/22

(52) U.S. Cl. CPC G06F 11/362; G06F 9/226

(57) ABSTRACT

Methods and systems for debugging microservices in a containerized service-based application are disclosed. The method may include obtaining a request to establish a communication pipeline between a microservice subject to debugging and a replicated instance of the microservice hosted by a debugging system. To establish a communication pipeline, a portion of traffic may be intercepted and redirected based on the request. The communication pipeline and the replicated instance of the microservice may allow the debugging system to extract information from the microservice relevant to debugging and correct an undesired operation of the microservice.

### FIELD

Embodiments disclosed herein relate generally to debugging microservices in a containerized service-based application. More particularly, embodiments disclosed herein relate to debugging microservices in a containerized service-based application by intercepting and redirecting traffic.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1B show diagrams illustrating a system in accordance with an embodiment.

FIGS. 2A-2B show interactions diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for debugging microservices in a containerized service-based application. To debug a microservice, information regarding an undesired operation of the microservice may be obtained. During operation, the microservice may utilize various resources, may generate information regarding the performance of the operation, and/or may provide a portion of computer implemented services provided by the containerized service-based application.

To provide computer implemented services, the containerized service-based application may host a deployment of containerized microservices. The deployment of containerized microservices may be managed by an orchestration system (e.g., Kubernetes). A microservice may be, for example, a container that hosts certain applications, drivers, etc. to access allocated resources (e.g. memory). One or more microservices may perform a containerized service-based process.

During performance of a containerized service-based process, an undesired operation of a microservice (e.g., error message, invalid result, slow performance, etc.) may be observed. When an undesired operation is observed, a request for debugging the microservice may be obtained.

When a request for debugging is obtained, a debugging system may be utilized to obtain information regarding a microservice subject to debugging. To obtain information regarding the microservice, access to resources allocated to the microservice may be requested. However, access to resources allocated to the microservice may include limits imposed by access control entities (e.g. security protocols). The limits imposed by access control entities may reduce the likelihood of obtaining information to (i) identify the cause of, and (ii) correct an undesired operation of the microservice.

To improve the likelihood an undesired operation of the microservice may be corrected, a debugging system may utilize a replicated instance of the microservice and a communication pipeline. The replicated instance of the microservice may be subject to reduced access limits. Reduced access limits may facilitate extraction of information from the microservice. For example, data may be directly read from memory, actions performed by the microservice may be controlled, etc. To extract information from the containerized microservice, information requests and responses may be communicated between the replicated instance of the microservice and the containerized microservice.

To communicate information between the replicated instance of the microservice and the containerized microservices (e.g., in a production environment), a communication pipeline may be established. To establish the communication pipeline, traffic through the containerized services may be redirected through other services configured to redirect traffic (e.g., listener services, interceptor services, etc.) to the debugging system.

Thus, embodiments disclosed herein may provide an improved method for debugging microservices in a containerized service-based application by establishing a communication pipeline between a replicated instance of a microservice on a debugging system and the microservice in a containerized service-based application.

In an embodiment, a method for debugging microservices in a containerized service-based application is provided. The method may include (i) obtaining a request from a debugging system, the request indicating that a communication pipeline to the debugging system is to be established; (ii) initiating performance of a containerized service-based process based on the request; and (iii) while the containerized service-based process is performed: (a) identifying, by a listener configured to monitor traffic being directed to a microservice of the microservices, that a portion of the traffic was initiated based on the request from the debugging system; (b) redirecting the portion of the traffic from the microservice to a replicated instance of the microservice that is hosted by the debugging system to obtain the communication pipeline between the microservice and the debugging system; (c) performing a debugging process using the communication pipeline and the replicated instance of the microservice to identify and correct an undesired operation of the microservice; and (d) providing computer implemented services using the corrected microservice.

The containerized service-based application may be hosted by a deployment, and the debugging system may be used by an entity tasked with managing operation of the containerized service-based application by providing debugging services for the microservices.

The debugging system and the deployment may be distinguishable hardware devices, and the debugging system and the deployment may be operably connected to each other.

The communication pipeline may be a logical entity adapted to: (i) identify data that is relevant to the request and directed to the microservice; and (ii) redirect the identified data from the microservice to the debugging system.

Initiating performance of the containerized service-based process may include sending a communication to at least one microservice of the microservices of the containerized service-based application.

The communication may include: (i) communication information for the debugging system; and (ii) a unique identifier for the request from the debugging system.

Identifying that the portion of the traffic was initiated based on the request from the debugging system may include: (i) obtaining information regarding content of the traffic, the information being usable to identify whether the unique identifier is present in the content of the traffic; and (ii) making a determination regarding whether the content comprises any instances of the unique identifier.

The traffic may include messages sent between the microservices to support operation of the containerized service-based application.

Redirecting the portion of the traffic may include: (i) forwarding the portion of the traffic to an interceptor service; and (ii) forwarding, by the interceptor service, the portion of traffic to the replicated instance of the microservice hosted by debugging system.

The replicated instance of the microservice may be subject to reduced security standards when compared to the microservice hosted by the deployment, and the reduced security standards may facilitate extraction of information regarding the service that may be relevant for debugging purposes.

The undesired operation of the microservice may observed in past operation of the microservice, and the undesired operation may be a basis for performing the debugging process.

The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

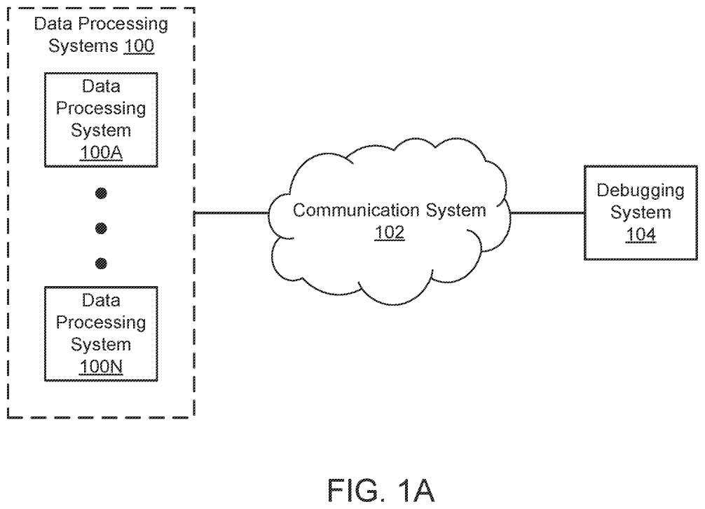

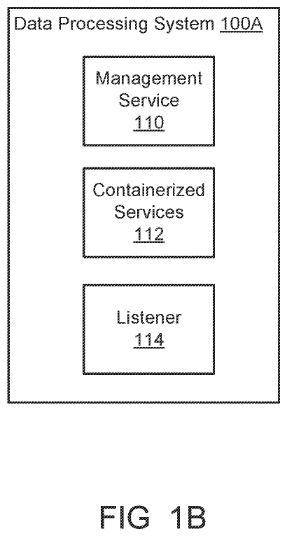

Turning to FIG. 1A, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, the system of FIG. 1A may include data processing systems 100, and debugging system 104. The computer implemented services may be provided by one or more components of the system of FIG. 1A.

Data processing systems 100 may include any number of data processing systems (100A-100N) that may each include any number of hardware components (e.g., processors, memory modules, storage devices, communications devices, etc.). The hardware components may support execution of any number and types of applications (e.g., software components, services, etc.) The data processing systems may cooperatively and/or individually provide all, or a portion of the computer implemented services.

To contribute to the computer implemented services, data processing systems 100 may host certain microservices, may be configured in certain manners (e.g., network communication configurations, software/hardware configurations, etc.), and/or may otherwise be modified to meet one or more requirements to contribute to the computer implemented services. Further, groups of data processing systems may cooperatively provide various services. For example, some data processing systems of a group may host some services to provide some functions while other data processing systems of a group may host different software to provide other functions which, in aggregate, allow desired computer implemented services to be provided.

To manage the services provided by data processing systems, an orchestration system (e.g., Kubernetes) may be utilized. The orchestration system may manage, for example, deployments of data processing systems 100, communication between data processing systems 100, modifications to microservices hosted by a data processing system (e.g., 100A), etc.

Microservices hosted by a data processing system may be containerized in a container framework (e.g., Docker). A containerized microservice may utilize resources allocated by the host data processing system to operate independently from other microservices. For example, a containerized microservice may operate in an isolated environment, framework, and/or security standards. One or more containerized microservices may cooperatively (e.g., process requests, send messages, etc.) perform a containerized service-based process.

During performance of a containerized service-based process, an undesired operation of a microservice (e.g., error message, invalid result, slow performance, etc.) may be observed. To observe operation of the microservice, performance of the microservice and/or the data processing system may be monitored and results may be logged. When an undesired operation is observed, a request for debugging the microservice may be generated.

The request for debugging may be obtained by debugging system 104. Debugging system 104 may be used by an entity (e.g., developer, administrator, etc.) tasked with managing operation of the containerized service-based application. To handle the request for debugging, the debugging system may identify the cause of the undesired operation and correct the undesired operation. To identify the cause, the debugging system may attempt to obtain information regarding the microservice by, for example, reading from memory spaces in the container. However, due to the independent operation of the microservice, access to information regarding the microservice may be limited by restrictions imposed by access control entities, such as the frameworks support operation of the containers. For example, security constraints may be imposed, intermediary steps of the microservice may be obscured, etc. The limits imposed by access control entities may reduce the likelihood of obtaining information necessary to successfully debug the microservice.

In general, embodiments disclosed here relate to systems and methods for debugging microservices in a containerized service-based application. To debug microservices in a containerized service-based application, a replicated instance of the microservice and a communication pipeline may be utilized.

When a request for a microservice to be debugged is obtained, debugging system 104 may initiate use of an interceptor service. To initiate the use of the interceptor service, debugging system 104 may provide instruction to a data processing system. For example, the debugging system may provide command line arguments or a configuration file to initiate the interceptor service. Because the interceptor service may be hosted on one of data processing systems 100, and services hosted on data processing systems 100 may communicate with each other, the interceptor service may communicate with other services for the purpose of debugging.

When initiated, the interceptor service may generate a unique identifier (e.g., a predetermined or random set of characters). The unique identifier may be provided to debugging system 104. Further, communication information (e.g., internet protocol address) for debugging system 104 may be registered with the interceptor service, and a listener may be created on the microservice subject to debugging.

Using the unique identifier, debugging system 104 may initiate traffic to data processing systems 100. The traffic (e.g., inter-microservice traffic) may be designed to cause responses by the microservice that is subject to debugging for debugging purposes (e.g., cause certain data to be exposed to the microservice). To initiate the traffic, a request may be sent to a first microservice hosted by a data processing system (e.g., 100A) with request information (e.g., service to be provided, unique identifier to identify request, etc.). The request may cause the traffic to be generated (e.g., an application programming interface may process the request and invoke any number of microservices which may initiate the traffic). Traffic may include requests and messages sent between microservices hosted on data processing systems 100 to support operation of the containerized service-based application.

When a portion of the traffic reaches the microservice subject for debugging, the listener may: (i) obtain information regarding content of the traffic, and (ii) determine whether the information includes any instances of the unique identifier provided by the debugging system. If the requests in the portion of the traffic includes the unique identifier provided by the debugging system, the listener may forward the portion of traffic to the interceptor service. Using the communication information registered by the debugging system, the interceptor service may then forward the portion of traffic to the debugging system. A communication pipeline may be established when the portion of traffic is forwarded to the debugging system.

Debugging system 104 may operate a replicated instance of the microservice subject to debugging. The replicated instance may operate in a same manner as the containerized microservice hosted in the data processing systems. For example, the replicated instance may utilize the same software, provide the same functionality, exhibit the same undesired operation, may have a similar state, etc. However, the replicated instance may operate with reduced security limits compared to the corresponding containerized microservice. For example, a less restrictive framework may be used to host the replicated instance of the microservice subject to debugging.

Thus, utilizing the replicated instance of the microservice and the communication pipeline between the replicated instance of the microservice and the containerized microservice, the debugging system may be able to obtain and interact with information without adhering to the limits imposed by access control entities in the containerized microservice. For example, data relevant to the request may be read from memory spaces, speed of a certain step of the process may be observed, etc.

Using the obtained information, causes of undesired operation of the microservice may be identified and corrected. For example, if a data result is identified to be erroneous at a given step of the microservice operation, the step may be identified and corrected, and the operation may be validated to ensure correct operation.

By utilizing the debugging approach discussed above, containerized service-based applications may be more likely to provide desired computer implemented services following successful debugging.

To provide the above noted functionality, the system may include data processing systems 100, and debugging system 104. Each of these components is discussed below.

Data processing systems 100 may, as discussed above, provide various computer implemented services to users thereof and/or other devices operably connected to data processing systems. To provide the computer implemented services, data processing systems 100 may include any number of individual data processing systems (e.g., 100A, 100B, etc.) that may each host various microservices. Refer to FIG. 1B for additional details regarding components of a data processing system (e.g., 100A).

A microservice hosted by a data processing system may subject to an undesired operation (e.g., inability to provide desired computer implemented service). The microservice may be debugged to identify and correct the undesired operation. The undesired operation may be identified via any process.

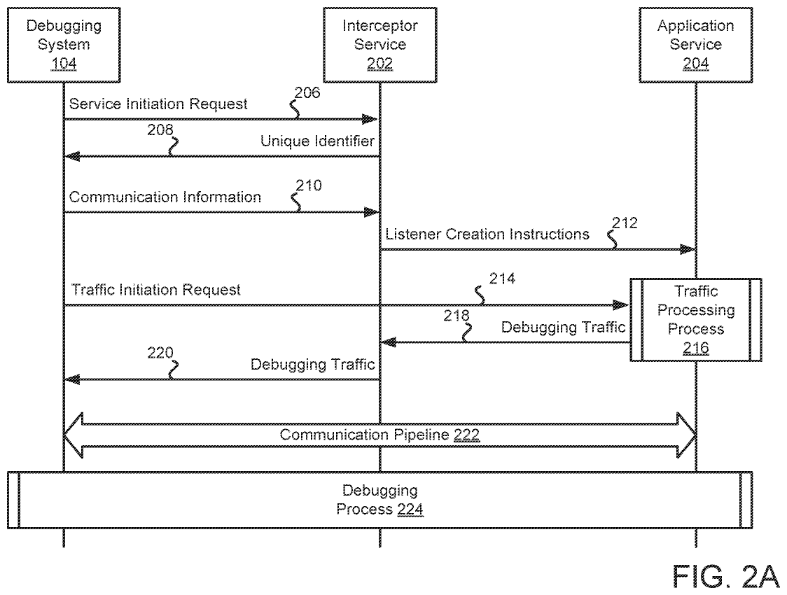

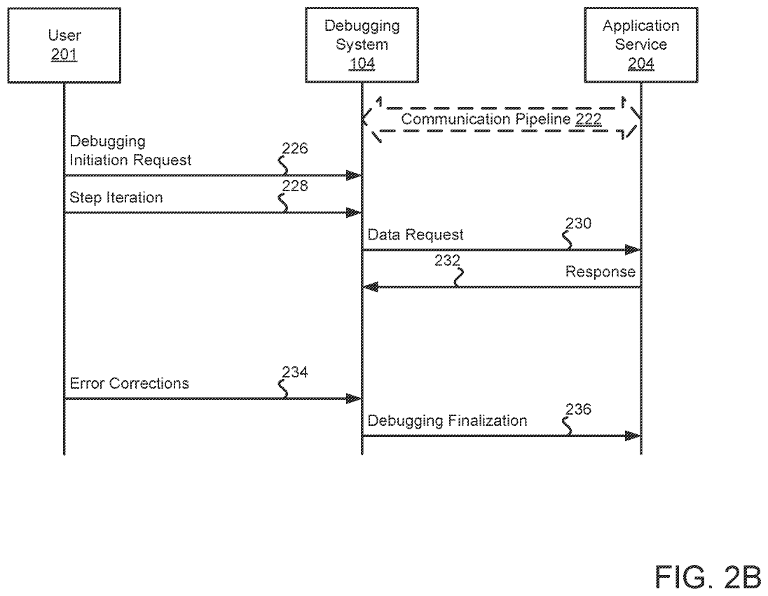

Debugging system 104 may, as discussed above, provide debugging services. To provide debugging services, debugging system 104 may operate a replicated instance of a microservice hosted by data processing systems 100, and may utilize a communication pipeline to data processing systems 100. To operate a replicated instance of a microservice, debugging system 104 may provide an interface to manage debugging services that may be used by an entity tasked with managing operation of debugging services. To utilize a communication pipeline to data processing systems 100, debugging system 104 may obtain a portion of traffic intended for the microservice subject for debugging and interact with information obtained from data processing systems 100. The communication pipeline may, therefore, allow the replicated microservice to operate as though it was hosted by data processing systems 100 (e.g., as though it was in a production environment where computer implemented services are provided to consumers). Refer to FIGS. 2A-2B for additional details regarding debugging services provided by debugging system 104.

Additionally, in contrast to the frameworks used to operate the microservices hosted by data processing systems 100, the frameworks of debugging system 104 that facilitate operation of the replicated instance of the microservice may be less restrictive. For example, the frameworks of debugging system 104 may allow for memory snooping, communication snooping, and/or other types of operation through which information usable to perform debugging may be obtained.

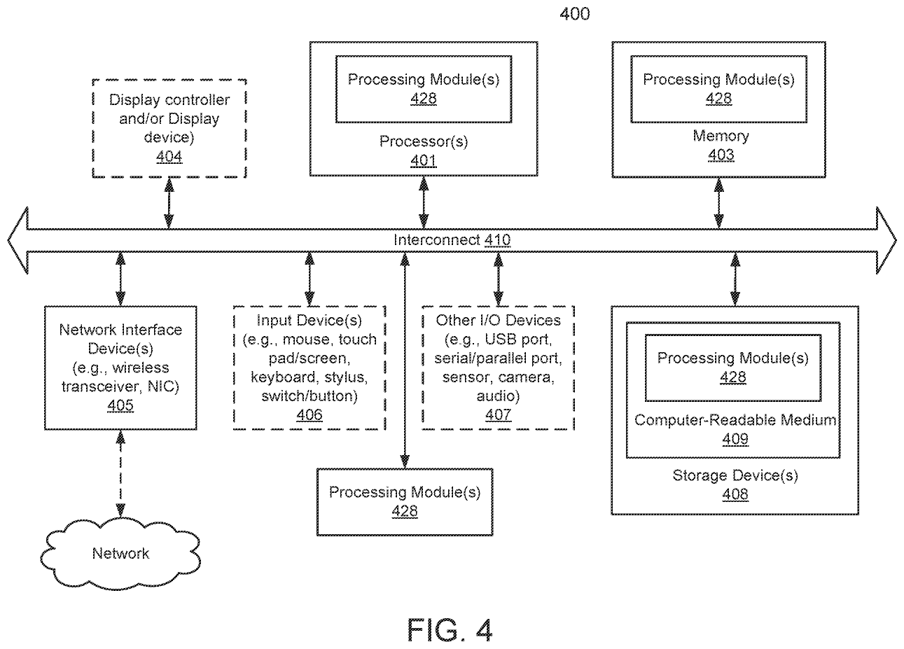

Communication system 102 may allow any of data processing systems 100 and debugging system 104 to communicate with one another (and/or with other devices not illustrated in FIG. 1A). To provide its functionality, communication system 102 may be implemented with one or more wired and/or wireless networks. Any of these networks may be a private network (e.g., the “Network” shown in FIG. 4), a public network, a virtual network (e.g., a virtual private network), and/or may include the Internet. For example, data processing systems 100 may be operably connected to debugging system 104 via the Internet, a private network, etc. Data processing systems 100 and debugging system 104 may be adapted to perform one or more protocols for communicating via communication system 102.

Any of (and/or components thereof) data processing systems 100, and debugging system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Turning to FIG. 1B, a diagram of a data processing system (e.g., 100A) in accordance with an embodiment is shown. Data processing systems 100 may include any number of data processing systems similar to the data processing system (e.g., 100A).

Data processing system (e.g., 100A) may host management service 110, any number of containerized services 112, listener 114 (and/or multiple instances of any of these entities), and/or other components. Each of these entities is discussed below.

Containerized services 112 may include any number of instances of containers that include various applications that provide desired services (e.g., microservices). Containerized services 112 may provide any number and type of computer implemented services in isolation and/or in combination with services hosted by other data processing systems.

For example, to provide services for a web application, data processing systems 100 may host microservices (e.g., user sign-in, image storage, data processing, payment processing, etc.). A data processing system (e.g., 100A) may host a portion of the microservices (e.g., user sign-in). Another data processing system (e.g., 100B) may host another portion of the microservices (e.g., image, storage, data processing, payment processing). The data processing systems may each host containerized services 112 that may provide the one or more of the microservices.

Management service 110 may manage containerized services 112. To manage containerized services 112, management service 110 may coordinate execution of services, monitor status (e.g., performance conditions, capacity, etc.), and/or facilitate traffic between services. To do so, management service 110 may obtain definitions (e.g., instructions regarding the desired operation of containerized services) from an orchestration system (e.g., Kubernetes).

Additionally, management service 110 may facilitate resource access in accordance with a framework. For example, management service 110 may abstract and provide access to portions of the abstracted computing resources (e.g., processor cycles, memory space, storage space, etc.) to containerized services 112. Through this access, containerized services 112 may contribute to computer implemented services.

The framework in which the resources access is provided may include various features to secure the performance of workloads. For example, in accordance with the framework, management services 110 may limit access to memory, storage, etc. By doing so, compromise of some of containerized services 112 may be less likely to result in compromise of others of containerized services 112. As noted above, debugging system 104 may not enforce similar security restrictions which may allow for additional information usable for debugging purposes to be obtained from replicated services when compared to the type and quantity of information that may be obtained from containerized services 112 for debugging purposes.

Listener 114 may provide traffic listening services. To provide traffic listening services, listener 114 may be created for a microservice subject for debugging. To create listener 114, an interceptor service (e.g., one of containerized services 112, may be a special management service as opposed to a production microservice that is present to allow for computer implemented services to be provided to service consumers) may initiate and configure listener 114 to monitor traffic being directed to the microservice. Listener 114 may obtain information regarding content of the traffic, determine whether a portion of the traffic is based on a debugging request, and/or facilitate redirection of the identified traffic to debugging system 104.

For example, listener 114 may be implemented as a service that monitors for and reads messages directed to a particular containerized service. The read/monitored messages (and/or copies thereof) may then be forwarded to a replicated instance of the particular containerized services.

The operation of listener 114 may allow for a secure communication pipeline to be established from the production environment to replicated services that exist outside of the production environment. By doing so, a broader range and type of debugging information may be obtained (e.g., from the replicated services) without needing to compromise the security standards specified by frameworks used by data processing systems 100.

Thus, as shown in FIG. 1A-1B, a system in accordance with an embodiment may debug microservices in a containerized service-based application by utilizing a communication pipeline between debugging system 104 and data processing systems 100.

To further clarify embodiments disclosed herein, interactions diagrams in accordance with an embodiment are shown in FIGS. 2A-2B. These interactions diagrams may illustrate how data may be obtained and used within the system of FIG. 1A-1B.

In the interaction diagrams, processes performed by and interactions between components of a system in accordance with an embodiment are shown. In the diagrams, components of the system are illustrated using a first set of shapes (e.g., 200, 202, etc.), located towards the top of each figure. Lines descend from these shapes. Processes performed by the components of the system are illustrated using a second set of shapes (e.g., 216, 224, etc.) superimposed over these lines. Interactions (e.g., communication, data transmissions, etc.) between the components of the system are illustrated using a third set of shapes (e.g., 206, 208, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 206 may occur prior to the interaction labeled as 208. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur during establishing of a communication pipeline between debugging system 104 and data processing systems 100.

Interceptor service 202 may be a new containerized service (e.g., similar to containerized services 112) that may be hosted on a data processing system.

Application service 204 may be a containerized service (e.g., similar to containerized services 112) that is to be debugged. For example, application service 204 may be a microservice that has previous observed undesired operation. While not shown, it will be appreciated that a debugging request for application service 204 to be debugged may have been provided to debugging system 104.

To establish a communication pipeline to facilitate debugging of application service 204, at interaction 206, the service initiation request may be provided to interceptor service 202 by debugging system 104. For example, the service initiation request may be defined and generated by debugging system 104 via (i) issuing command line arguments, (ii) providing a configuration file, and/or via any other processes. By providing the service initiation request to interceptor service 202, interceptor service 202 may provide connection services between debugging system 104 and application service 204.

At interaction 208, the unique identifier may be provided to debugging system 104 by interceptor service 202. For example, the unique identifier may be generated and provided to debugging system 104 via (i) displaying on an interface, (ii) storing in a variable, (iii) providing a file, and/or any other process. By providing the unique identifier to debugging system 104, debugging system 104 may provide debugging services for a microservice subject for debugging.

At interaction 210, communication information may be provided to interceptor service 202 by debugging system 104. For example, the communication information may be generated and provided to interceptor service 202 via (i) transmission via a message, (ii) storing in a storage with subsequent retrieval by interceptor service 202, (iii) via a publish-subscribe system where interceptor service 202 subscribes to updates from debugging system 104 thereby causing a copy of the communication information to be propagated to interceptor service 202, and/or via other processes. The communication information may include, for example, an internet protocol address for debugging system 104 and/or other types of information that allow for communications to be directed to debugging system 104. By providing the communication information to interceptor service 202, interceptor service 202 may provide registration services to enable debugging traffic to be routed to debugging system 104.

At interaction 212, listener creation instructions may be provided to application service 204 by interceptor service 202. For example, the listener creation instructions may be defined and generated by interceptor service 202 via (i) transmission via a message, (ii) providing a configuration file, and/or via any other processes. The listener creation instructions may include, for example, the unique identifier provided at interaction 208. By providing the listener creation instructions to application service 204, application service 204 may provide listening services to identify and redirect debugging traffic. While shown with respect to application service 204, the listener creation instructions may be provided to other entities. For example, the listener creation instructions may be provided to management entities of the environment in which application service 204 exists (e.g., the application service may lack native permissions to establish a listener). By doing so, a companion service may be created, application service 204 may be reconfigured to also provide the functionality of a listener, etc.

At interaction 214, the traffic initiation request may be provided to application service 204 by debugging system 104. For example, the traffic initiation request may be generated and provided by debugging system 104 via (i) transmission via a message, (ii) issuing command line arguments, and/or any other processes. Traffic initiation request may include, for example, request header information and the unique identifier provided at interaction 208. By providing the traffic initiation request to application service 204, application service 204 may provide traffic processing processes to invoke any number of microservices to process requests and identify debugging traffic (e.g., portion of traffic for the microservice subject to debugging). While shown as being provided directly to application service 204, it will be appreciated that the traffic initiation request may be provided to other entities which in turn provide the request and/or information based on the request to application service 204. For example, traffic initiation request may be a request for a computer implemented service to be provided. The request may initially be directed to an API which may in turn generate various invocations of any number of microservices, which may in turn invoke the functionality of application service 204. During these invocations, the header information/unique identifier may be propagated such that when the messages invoking the functionality of application service 204 reach application service 204 (and/or a corresponding listener), the messages can be identified as relating to debugging traffic.

To reroute debugging traffic to debugging system 104, traffic processing process 216 may be performed. During traffic processing process 216, traffic may be transmitted between microservices and the traffic may be analyzed by the listener created at interaction 212. The traffic may include (i) messages (e.g., requests and responses) sent between microservices, (ii) request identification information (e.g., unique identifier), and/or any other information regarding a service provided by a microservice. To analyze the traffic, the listener may monitor the traffic obtained by the microservice and identify identification information for a portion of the traffic. If a portion of traffic is determined to include the unique identifier provided by debugging system 104, the debugging traffic may be redirected to debugging system 104.

At interaction 218, the debugging traffic may be provided to interceptor service 202 by application service 204. For example, the debugging traffic may be identified during traffic processing process 216 and forwarded to interceptor 202. By providing the debugging traffic to interceptor service 202, interceptor service 202 may forward the debugging traffic to debugging system 104.

At interaction 220, the debugging traffic may be provided to debugging system 104 by interceptor service 202. By providing the debugging traffic to debugging system 104, communication pipeline 222 may be established between debugging system 104 and application service 204 to enable a microservice of application service 204 to be debugged.

In an embodiment, communication pipeline 222 may be established between debugging system 104 and application service 204 by virtue of the debugging traffic that flows to debugging system 104. Utilizing communication pipeline 222, debugging system 104 may obtain and interact with information from application services 204. For example, debugging system 104 may access data for debugging purposes without adhering to the limits imposed by access control entities that manage application services 204.

To debug a microservice, debugging process 224 may be performed. During debugging process 224, service steps may be inspected, data may be obtained, and errors may be identified and corrected. Refer to FIG. 2B for additional information regarding debugging process 224. The result of debugging process 224 may be a corrected operation of a microservice hosted by application service 204.

Thus, via processes and interactions shown in FIG. 2A, a communication pipeline may be established to obtain information regarding a microservice subject for debugging.

Turning to FIG. 2B, a second interaction diagram in accordance with an embodiment is shown. FIG. 2B may illustrate a process for debugging a microservice via a communication pipeline between a debugging system and the microservice hosted by an application service.

To debug a microservice, a user 201 may be tasked with managing operation of the containerized service-based application and/or debugging services. For example, user 201 may be (i) a developer, (ii) a site reliability engineer, and/or any other entity.

Communication pipeline 222 is shown to indicate that any interactions in FIG. 2B may utilize the communication pipeline between debugging system 104 and application services 204, as discussed with respect to FIG. 2A.

At interaction 226, a debugging initiation request may be provided to debugging system 104 by user 201. For example, the debugging initiation request may be provided to debugging system 104 by (i) opening a debugging mode, (ii), configuring debugging tools, and/or any other methods.

At interaction 228, step iteration may be provided to debugging system 104 by user 201. For example, step iteration may be provided to debugging system 104 by (i) issuing commands, (ii) selecting steps of the service to execute, (iii) creating break points, and/or any other methods. By providing step iteration to debugging system 104, debugging system 104 may provide an interface to enable user 201 to interact with application service 204.

At interaction 230, the data request may be provided to application 204 by debugging system 104. For example, the data request may be provided to application service 204 by (i) sending a message, (ii) providing a file with request information, and/or any other methods. For example, similar processes discussed with respect to interaction 214 may be performed.

At interaction 232, a response may be provided to debugging system 104 by application service 204. For example, the response may include (i) data requested by the data request at interaction 230, (ii) confirmation of an action performed, and/or any other information. By providing the response to debugging system 104, debugging system 104 may identify errors to be corrected.

A replicated instance of application service 204 may be hosted by debugging system 104. The replicated service may have a similar state but operate with reduced security limits compared to application service 204. To identify errors to be corrected, the replicated service may use the response obtained at interaction 232 to provide information usable by user 201 to debug an undesired operation of application service 204. For example, the information may be provided by (i) monitoring the memory/activity of the replicated service during use of the response, (ii) presenting the information (e.g., metrics, variables, etc.) via an interface interactable by user 201, ad/or any other process.

At interaction 234, the error corrections may be provided to debugging system 104 by user 201. For example, the error corrections may be provided by (i) analyzing the response obtained at interaction 232, (ii) identifying the cause of an undesired operation, and (ii) correcting the cause of the undesired operation, and/or any other process.

At interaction 236, the debugging finalization may be provided to application service 204 by debugging system 104. For example, the debugging finalization may be provided by (i) terminating the communication pipeline, (ii) deploying the corrected service, and/or any other process.

Thus, via processes and interactions shown in FIG. 2B, a communication pipeline may be utilized to identify and correct an undesired operation of a microservice.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

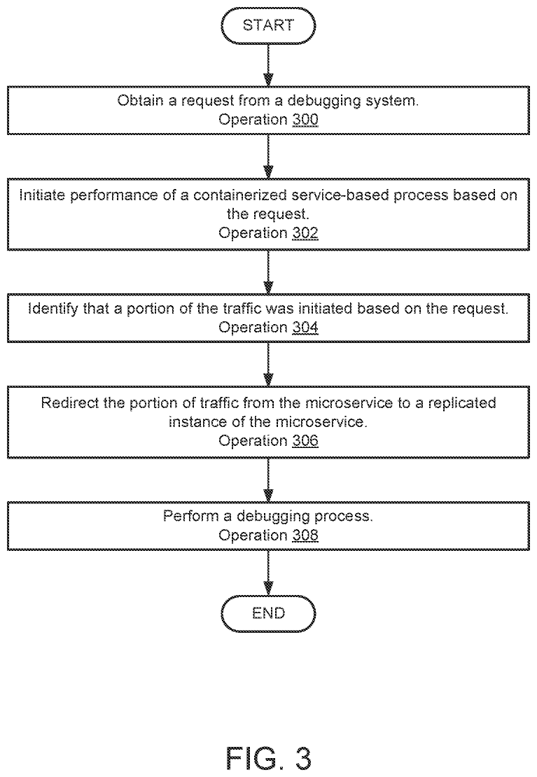

As discussed above, the components of FIGS. 1A-lB may perform various methods to debug microservices in a containerized service-based application. FIG. 3 illustrates methods that may be performed by the components of the system of FIGS. 1A-lB. In the diagrams discussed below and shown in FIG. 3, any of the operations may be repeated, performed in different orders, and/or performed in parallel with or in a partially overlapping in time manner with other operations.

Turning to FIG. 3, a first flow diagram illustrating a method of debugging microservices in a containerized service-based application in accordance with an embodiment is shown. The method may be performed, for example, by any of the components of the system of FIGS. 1A-1B, and/or other components not shown therein.

Prior to operation 300, a request for debugging a microservice may be generated. The request for debugging a microservice may be generated by (i) observing an undesired operation of the microservice, (ii) monitoring performance of the microservice, and/or any other methods.

At operation 300, a request may be obtained from a debugging system that indicates a communication pipeline is to be established. The request may be obtained by (i) receiving a request sent by the debugging system, (ii) subscribing to updates sent by the debugging system, and/or any other methods. The request may include (i) communication information for the debugging system (e.g., internet protocol address), (ii) a unique identifier for the request, and/or any information usable to establish communication with the debugging system.

At operation 302, performance of a containerized service-based process may be initiated based on the request. The performance may be initiated by (i) sending a communication to at least one microservice of the microservices of the containerized service-based application, (ii) sending an application programming interface request that may invoke any number of microservices, and/or any other methods.

At operation 304, a portion of the traffic may be identified to have been initiated based on the request. The portion of traffic may be identified by a listener configured to monitor traffic being directed to the microservice by (i) obtaining information regarding content of the traffic (e.g., request header information), (ii) making a determination regarding whether the content comprises any instances of the unique identifier, and/or any other methods.

At operation 306, the portion of the traffic identified at operation 304 from the microservice may be redirected to a replicated instance of the microservice hosted by the debugging system. The portion of the traffic may be redirected by (i) forwarding the portion of the traffic to an interceptor service, (ii) forwarding, by the interceptor service, the portion of the traffic to the replicated instance of the microservice, and/or any other methods. The replicated instance of the microservice may be subject to reduced security standards when compared to the microservice hosted by the deployment, and the reduced security standards may facilitate extraction of information regarding the microservice that is relevant for debugging purposes.

At operation 308, a debugging process may be performed. The debugging process may be performed by (i) utilizing the communication pipeline, (ii) extracting information regarding the microservice that may be relevant for debugging purposes, (iii) identifying causes of an undesired operation of the microservice, (iv) correcting the undesired operation of the microservice, and/or any other debugging actions.

The method may end following operation 308.

Using the method shown in FIG. 3, the likelihood of an undesired operation of a microservice in a containerized service-based application being corrected may be improved by using a communication pipeline and a replicated instance of a microservice to debug the microservice.

Any of the components illustrated in FIGS. 1A-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for debugging microservices in a containerized service-based application, the method comprising:
obtaining a request from a debugging system, the request indicating that a communication pipeline to the debugging system is to be established;
initiating performance of a containerized service-based process based on the request;
while the containerized service-based process is performed:
identifying, by a listener configured to monitor traffic being directed to a microservice of the microservices, that a portion of the traffic was initiated based on the request from the debugging system;
redirecting the portion of the traffic from the microservice to a replicated instance of the microservice that is hosted by the debugging system to obtain the communication pipeline between the microservice and the debugging system;
performing a debugging process using the communication pipeline and the replicated instance of the microservice to identify and correct an undesired operation of the microservice; and
providing computer implemented services using the corrected microservice.

2. The method of claim 1, wherein the containerized service-based application is hosted by a deployment, and the debugging system is used by an entity tasked with managing operation of the containerized service-based application by providing debugging services for the microservices.

3. The method of claim 2, wherein the debugging system and the deployment are distinguishable hardware devices, and the debugging system and the deployment are operably connected to each other.

4. The method of claim 1, wherein the communication pipeline is a logical entity adapted to:
identify data that is relevant to the request and directed to the microservice, and redirect the identified data from the microservice to the debugging system.

5. The method of claim 1, wherein initiating performance of the containerized service-based process comprises:
sending a communication to at least one microservice of the microservices of the containerized service-based application.

6. The method of claim 5, wherein the communication comprises:
communication information for the debugging system; and
a unique identifier for the request from the debugging system.

7. The method of claim 6, wherein identifying that the portion of the traffic was initiated based on the request from the debugging system comprises:
obtaining information regarding content of the traffic, the information being usable to identify whether the unique identifier is present in the content of the traffic; and
making a determination regarding whether the content comprises any instances of the unique identifier.

8. The method of claim 1, wherein the traffic comprises messages sent between the microservices to support operation of the containerized service-based application.

9. The method of claim 1, wherein redirecting the portion of the traffic comprises:
forwarding the portion of the traffic to an interceptor service; and
forwarding, by the interceptor service, the portion of traffic to the replicated instance of the microservice hosted by debugging system.

10. The method of claim 9, wherein the replicated instance of the microservice is subject to reduced security standards when compared to the microservice hosted by the deployment, and the reduced security standards facilitates extraction of information regarding the service that is relevant for debugging purposes.

11. The method of claim 1, wherein the undesired operation of the microservice is observed in past operation of the microservice, and the undesired operation is a basis for performing the debugging process.

12. A non-transitory machine-readable medium having instructions stored therein, which when executed by a processor, cause the processor to perform operations for debugging microservices in a containerized service-based application, the operation comprising:
obtaining a request from a debugging system, the request indicating that a communication pipeline to the debugging system is to be established;
initiating performance of a containerized service-based process based on the request;
while the containerized service-based process is performed:
identifying, by a listener configured to monitor traffic being directed to a microservice of the microservices, that a portion of the traffic was initiated based on the request from the debugging system;
redirecting the portion of the traffic from the microservice to a replicated instance of the microservice that is hosted by the debugging system to obtain the communication pipeline between the microservice and the debugging system;
performing a debugging process using the communication pipeline and the replicated instance of the microservice to identify and correct an undesired operation of the microservice; and
providing computer implemented services using the corrected microservice.

13. The non-transitory machine-readable medium of claim 12, wherein the containerized service-based application is hosted by a deployment, and the debugging system is used by an entity tasked with managing operation of the containerized service-based application by providing debugging services for the microservices.

14. The non-transitory machine-readable medium of claim 13, wherein the debugging system and the deployment are distinguishable hardware devices, and the debugging system and the deployment are operably connected to each other.

15. The non-transitory machine-readable medium of claim 12, wherein the communication pipeline is a logical entity adapted to:
identify data that is relevant to the request and directed to the microservice, and redirect the identified data from the microservice to the debugging system.

16. The non-transitory machine-readable medium of claim 12, wherein initiating performance of the containerized service-based process comprises:
sending a communication to at least one microservice of the microservices of the containerized service-based application.

17. A data processing system, comprising:
a processor; and
a memory coupled to the processor to store instructions, which when executed by the processor, cause the processor to perform operations for debugging microservices in a containerized service-based application, the operations comprising:
obtaining a request from a debugging system, the request indicating that a communication pipeline to the debugging system is to be established;
initiating performance of a containerized service-based process based on the request;
while the containerized service-based process is performed:
identifying, by a listener configured to monitor traffic being directed to a microservice of the microservices, that a portion of the traffic was initiated based on the request from the debugging system;
redirecting the portion of the traffic from the microservice to a replicated instance of the microservice that is hosted by the debugging system to obtain the communication pipeline between the microservice and the debugging system;
performing a debugging process using the communication pipeline and the replicated instance of the microservice to identify and correct an undesired operation of the microservice; and
providing computer implemented services using the corrected microservice.

18. The data processing system of claim 17, wherein the containerized service-based application is hosted by a deployment, and the debugging system is used by an entity tasked with managing operation of the containerized service-based application by providing debugging services for the microservices.

19. The data processing system of claim 18, wherein the debugging system and the deployment are distinguishable hardware devices, and the debugging system and the deployment are operably connected to each other.

20. The data processing system of claim 17, wherein the communication pipeline is a logical entity adapted to:
identify data that is relevant to the request and directed to the microservice, and redirect the identified data from the microservice to the debugging system.
